(19) United States
(12) Patent Application Publication
(10) Pub. No.: US 2020/0079912 A1
(43) Pub. Date: Mar. 12, 2020

(54) NANOSTRUCTURED BLOCK COPOLYMER FILM COMPRISING AN AMORPHOUS BLOCK

(71) Applicants: Arkema France, Colombes (FR); Centre National de la Recherche Scientifique, Paris (FR); Université Toulouse III - Paul Sabatier, Toulouse (FR)

(72) Inventors: Christophe Navarro, Bayonne (FR); Didier Bourissou, Plaisance Du Touch (FR); Blanca Martin-Vaca, Toulouse (FR); Franck Kayser, Toulouse (FR)

(73) Assignees: Arkema France, Colombes (FR); Centre National de la Recherche Scientifique, Paris (FR); Université Toulouse III - Paul Sabatier, Toulouse (FR)

(21) Appl. No.: 16/467,241

(22) PCT Filed: Dec. 13, 2017
(86) PCT No.: PCT/FR2017/053555

§ 371 Date: Jun. 6, 2019

(30) Foreign Application Priority Data
Dec. 14, 2016 (FR) 1662466

(51) Int. Cl. C08G 81/02; C08G 63/08; C08J 5/18

(52) U.S. Cl. CPC C08G 81/027; B82Y 30/00; C08J 5/18; C08G 63/08

(57) ABSTRACT

The invention relates to a block copolymer film nanostructured in nanodomains, said copolymer comprising at least one first biodegradable block and a second block of a different chemical nature than the first block, said block copolymer being characterized in that the first biodegradable block is amorphous and in that the second block is derived from an oligomer or a polymer bearing a hydroxyl function on at least one end and acting as macro-initiator of the polymerization of the first block.

### FIELD OF THE INVENTION

The present invention relates to the field of nanostructured block copolymers having nanodomains oriented in a particular direction.

More particularly, the invention relates to a block copolymer film comprising at least one amorphous block, able to be readily eliminated after structuring, and having a high phase segregation, with a small L₀ period, preferably of less than 20 nm.

The term “period”, denoted L₀ in the remainder of the description, is intended to mean the minimum distance separating two adjacent domains having the same chemical composition, separated by a domain having a different chemical composition.

### PRIOR ART

The development of nanotechnologies has made it possible to constantly miniaturize products in the field of microelectronics and microelectromechanical systems (MEMS) especially. At the current time, conventional lithography techniques no longer make it possible to meet these constant needs for miniaturization, as they do not make it possible to produce structures with dimensions of less than 60 nm.

It has therefore been necessary to adapt the lithography techniques and to create etching resists which make it possible to create increasingly small patterns with a high resolution. With block copolymers, it is possible to structure the arrangement of the constituent blocks of the copolymers by phase segregation between the blocks, thus forming nanodomains, at scales of less than 50 nm. Due to this ability to be nanostructured, the use of block copolymers in the fields of electronics or optoelectronics is now well known.

Among nanolithography resists, the hitherto most widely studied block copolymer films are films based on polystyrene-b-poly(methyl methacrylate), hereinafter denoted PS-b-PMMA. Accordingly, in the document entitled “Directed self-assembly of block copolymers for nanolithography: fabrication of isolated features and essential integrated circuit geometries”, ACSNano 2007, 1, 168, M. P. Stoykovich et al describe advanced lithography processes based on the self-assembly of block copolymers and using PS-b-PMMA (polystyrene-b-poly(methyl methacrylate

e)) resists. To be able to use such a block copolymer film as an etching resist, one block of the copolymer must be selectively removed in order to create a porous film of the residual block, the patterns of which may be subsequently transferred by etching to an underlying layer. Regarding the PS-b-PMMA film, the PMMA (poly(methyl methacrylate)) is usually removed selectively in order to create a resist of residual PS (polystyrene). In order to create such resists, the nanodomains must be oriented perpendicular to the surface of the underlying layer. Such structuring of the domains requires particular conditions such as the preparation of the surface of the underlying layer, but also the composition of the block copolymer. An important factor is the phase segregation factor, also referred to as the Flory-Huggins interaction parameter and denoted by “χ”. Specifically, this parameter makes it possible to control the size of the nanodomains. More particularly, it defines the tendency of the blocks of the block copolymer to separate into nanodomains. Thus, the product χN of the Flory-Huggins parameter χ and of the degree of polymerization N gives an indication as to the compatibility of two blocks and whether they may separate at a given temperature. For example, a diblock copolymer of strictly symmetrical composition separates into microdomains if the product χN is greater than 10.49. If this product χN is less than 10.49, the blocks mix together and phase separation is not observed at the observation temperature.

Because of the constant needs for miniaturization, it is generally sought to increase this degree of phase separation, in order to produce nanolithography resists which make it possible to obtain very high resolutions, typically less than 20 nm, and preferably less than 15 nm, while at the same time retaining certain basic properties of the block copolymer, such as a good temperature resistance of the block copolymer, or a depolymerization of the PMMA under UV treatment when the block copolymer is a PS-b-PMMA, etc.

In Macromolecules, 2008, 41, 9948, Y. Zhao et al. estimated the Flory-Huggins parameter for a PS-b-PMMA block copolymer. The Flory-Huggins parameter χ obeys the following equation: χ=a+b/T, where the values a and b are constant specific values dependent on the nature of the blocks of the copolymer and T is the temperature of the heat treatment applied to the block copolymer in order to enable it to organize itself, that is to say in order to obtain a phase separation of the domains, an orientation of the domains and a reduction in the number of defects. More particularly, the values a and b respectively represent the entropic and enthalpic contributions. Thus, for a PS-b-PMMA block copolymer, the phase segregation factor obeys the following equation: χ=0.0282+4.46/T.

This low value of the Flory-Huggins interaction parameter χ (0.04 at 298 K) therefore limits the advantage of block copolymers based on PS and PMMA for the production of structures having very high resolutions.

To overcome this problem, M. D. Rodwing et al., in the article entitled “Polylactide-Poly(dimethylsiloxane)-Polylactide triblock copolymers as multifuntional materials for nanolithographic application,” ACSNano 2010, 4, 725, have shown that the chemical nature of the two copolymer blocks can be changed to increase the Flory-Huggins parameter χ and to produce a desired morphology with periodicities below 20 nm. Such results have for example been obtained with poly(lactic acid-b-dimethylsiloxane-b-lactic acid) PLA-b-PDMS-b-PLA copolymers.

However, it has also been demonstrated by H. Takahashi et al, in the article entitled “Defectivity in laterally confined lamella-forming diblock copolymers: thermodynamic and kinetic aspects,” Macromolecules 2012, 45, 6253, that the Flory-Huggins χ parameter has an influence on the kinetics of segregation and therefore on the kinetics of defect reduction. A high value for the Flory-Huggins χ parameter results in a slowing of the kinetics of segregation causing the appearance of defects at the moment when the domains are organized.

Research has therefore shifted onto other block copolymers, especially block copolymers combining polyester-type blocks with blocks of a different nature, of polyether or polyolefin type, for example. The development of selective polymerization methods, with a controlled and living character, has enabled the preparation of block copolymers comprising blocks of varied chemical natures and a well-defined structure. In some of these polymers, the blocks have low compatibility, which results in segregation leading to nanostructuring. The chemical nature of the blocks studied is very diverse and in recent years increased attention has been paid to incorporating a biodegradable block, especially of polyester type, which can be readily eliminated after nanostructuring. PLA (polylactic acid) and to a lesser extent PCL (polycaprolactone) are the most widely studied polyesters in this context, in particular in combination with PS (polystyrene), PDMS (polydimethylsiloxane) or else PTMSS (polytrimethylsilylstyrene) blocks. Thus, the document entitled “Ordered Nanoporous Polymers from Polystyrene-Polylactide Block Copolymers”, A. S. Zalusky et al, J. AM. CHEM. SOC. 2002, 124, 12761-12773 and the document entitled “Thin Film Self-Assembly of Poly(trimethylsilylstyrene-b-_{D,L}-lactide) with Sub-10 nm Domains”, J. D. Cushen et al, Macromolecules, 2012, 45, 8722-8728, describe, respectively, the preparation of PS-b-PLA diblock copolymers and of PTMSS-b-PLA diblock copolymers, having nanodomains less than 10 nm in size, and the period of which is between 12 and 15 nm. Finally, the document entitled “High χ-low N Block Polymers: How Far Can We Go?”, C. Sinturel et al, ACS Macro Letters, 2015, 4, 1044-1050, describes block copolymers combining PLA with PS, PDMS or PTMSS and demonstrates the fact that a block copolymer of low number-average molecular weight, typically of less than 20,000 g/mol, enables structuring in nanodomains less than 10 nm in size and with a period L₀ of less than 20 nm.

The applicant was more particularly concerned with polyesters of polylactone type. Ring-opening polymerization of lactones has been studied for several years, since the polymers resulting therefrom have a certain industrial interest in various fields due to their biodegradability and biocompatibility. Thus, copolymers with biodegradable polyesters may be used as encapsulant in medicaments or as biodegradable implants, in particular in orthopaedics, in order to do away with operations which were necessary in the past in order to remove metal parts such as pins, for example. Such polymers may also be used in coatings and plastics formulations. The applicant was therefore concerned with these polymers, for incorporating them into block copolymers due to their biodegradability, in order to be able to readily eliminate them after nanostructuring and enable the creation of a residual porous film intended to act as nanolithography resist, for DSA (directed self-assembly) lithography applications. Polycaprolactones and polybutyrolactones also have good physical and chemical properties and good thermal stability up to temperatures of at least 200-250° C.

Organocatalysts have been developed in order to enable the ring-opening polymerization of lactones, in particular ε-caprolactone, denoted “ε-CL” in the remainder of the description. Patent applications WO2008104723 and WO200810472 and also the paper entitled “Organo-catalyzed ROP of ε-caprolactone: methanesulfonic acid competes with trifluoromethanesulfonic acid”, Macromolecules, 2008, Vol. 41, pp. 3782-3784, especially demonstrated the effectiveness of methanesulfonic acid, denoted “MSA”, as catalyst of the polymerization of ε-caprolactone.

The abovementioned documents also describe that, in combination with a protic initiator of alcohol type, MSA is able to promote the controlled polymerization of the ε-caprolactone cyclic monomer. In particular, the protic initiator enables fine control of the mean molar masses and also the chain ends.

Moreover, it is also known that when the blocks of a block copolymer exhibit high glass transition T_{g} or melting Tₘ temperatures, it may be necessary to perform annealation at a high annealation temperature to favour nanostructuration. If the annealation treatment must be conducted at a high temperature, typically above 200° C., and with slower segregation kinetics, this may cause stability problems in the copolymer and higher processing costs.

The applicant therefore focused on the behaviour of block copolymers comprising a biodegradable block.

### Technical Problem

The aim of the invention is thus to overcome at least one of the disadvantages of the prior art. The invention relates in particular to proposing a block copolymer film comprising at least a first biodegradable block, said block copolymer film being able to nanostructure itself into nanodomains with a controlled period below 20 nm, after annealation at moderate temperature, below 200° C. and preferably below 180° C. and with kinetics below 30 minutes, preferably below 15 minutes.

### BRIEF DESCRIPTION OF THE INVENTION

Surprisingly, it was discovered that a block copolymer film nanostructured in nanodomains, said copolymer comprising at least one first biodegradable block and a second block of a different chemical nature than the first block, said block copolymer being characterized in that the first biodegradable block is amorphous and in that the second block is derived from an oligomer or a polymer bearing a hydroxyl function on at least one end and acting as macro-initiator of the polymerization of the first block, allows the production of nano-domains with a period below 20 nm after annealation at a temperature of between 130 and 170° C. for a duration of between 5 and 10 minutes.

According to other optional features of this block copolymer film:
the first amorphous biodegradable block is of polyester type;
the first amorphous biodegradable block of polyester type is chosen from ε- or δ-lactone polymers substituted or unsubstituted by aryl or alkyl groups;
the first amorphous biodegradable block of polyester type is an amorphous caprolactone copolymer (PCLₐₘ) formed from ε-caprolactone and at least one other co-monomer chosen from ε- or δ-lactones substituted by aryl or alkyl groups;
the block copolymer is a diblock or triblock copolymer;
co-monomers constituted of amorphous caprolactone copolymer (PCLₐₘ) are ε-caprolactone (ε-CL) and 4-phenyl-caprolactone (4-Ph-ε-CL);
the molar ratio between the ε-CL/4-Ph-ε-CL co-monomers is comprised between 6/1 and 3/1, preferably between 6/1 and 4/1;
the number-average molecular weight of each block of amorphous caprolactone copolymer (PCLₐₘ) is comprised between 1000 and 30,000 g/mol, preferably between 2000 and 15,000 g/mol;
the number-average molecular weight of the block copolymer is between 7000 and 33,000 g/mol;
the molar ratio of ε-caprolactone and 4-Ph-ε-CL co-monomers on each hydroxyl function of the macro-initiator is comprised between 16/1 and 130/1;
the second block, forming the macro-initiator, is derived from an oligomer or from a mono- or polyhydroxylated polymer chosen from: (alkoxy)polyalkylene glycols, such as (methoxy)polyethylene glycol (MPEG/PEG), polypropylene glycol (PPG) and polytetramethylene glycol (PTMG); poly(alkyl)alkylene adipate diols, such as poly(2-methyl-1,3-propylene adipate) diol (PMPA) and poly(1,4-butylene adipate) diol (PBA); polysiloxanes, such as mono- or dihydroxylated polydimethylsiloxane (PDMS), mono- or di-carbinols, or optionally hydrogenated mono- or dihydroxylated polydienes, such as α,γ-dihydroxylated polybutadiene or α,ω-dihydroxylated polyisoprene, preferably hydrogenated or non-hydrogenated hydroxytelechelic polybutadiene; or mono- or polyhydroxylated polyalkylenes such as mono- or polyhydroxylated polyisobutylene; modified or unmodified polysaccharides such as starch, chitin, chitosan, dextran and cellulose; or a vinyl co-oligomer or copolymer from the family of acrylic, methacrylic, styrene or diene polymers, which results from copolymerization between acrylic, methacrylic, styrene or diene monomers and functional monomers having a hydroxyl group, or a vinyl copolymer obtained by radical polymerization that may be controlled or not, in which the radical initiator and/or the control agent bear at least one hydroxyl or thiol function;

Starting from this block copolymer film, it is possible to produce a nanolithography resist by removing the first biodegradable amorphous block to form a porous pattern perpendicular to the surface to be etched which has a period L₀≤20 nm.

Other distinctive features and advantages of the invention will become apparent on reading the following description given by way of illustrative and non-limiting example.

### DETAILED DESCRIPTION OF THE INVENTION

The term “monomer” as used relates to a molecule which can undergo a polymerization.

The term “polymerization” as used relates to the process of conversion of a monomer or of a mixture of monomers into a polymer.

The term “oligomer” as used relates to a small polymeric compound comprising between 2 and 30 monomers, i.e. whose degree of polymerization is between 2 and 30.

The term “copolymer block” or “block” is intended to mean a polymer which groups together several monomer units of several types or of the same type.

The term “block copolymer” is intended to mean a polymer comprising at least two blocks as defined above, the two blocks being different from one another and having a phase segregation parameter such that they are not miscible and separate into nanodomains at a temperature below the degradation temperature of the block copolymer.

The term “miscibility” used above is used to mean the ability of two compounds to mix together completely so as to form a homogeneous phase.

The block copolymer according to the invention advantageously comprises a first biodegradable block, able to be readily eliminated after nanostructuring the copolymer, so as to be able to produce a porous film intended to act as nanolithography resist. The block copolymer comprises at least one other block different from the first and which is incompatible with the first block, that is to say that they cannot be mixed and they separate into nanodomains.

Advantageously, the first biodegradable block exhibits an amorphous structure.

More particularly, the first amorphous biodegradable block is of polyester type. Among polyesters capable of forming this first amorphous block, amorphous ε-lactone polymers monosubstituted by linear or branched, optionally substituted aryl or alkyl groups, or amorphous polymers of δ-lactone monosubstituted by linear or branched, optionally substituted aryl or alkyl groups may for example be chosen. This may for example be a polymer of the amorphous polybutyrolactone type (noted PBLₐₘ), or of the amorphous polycaprolactone type (noted, for simplification, PCLₐₘ in the rest of the description).

In a more preferred manner, the first amorphous block is an amorphous polycaprolactone (PCLₐₘ). PCL is a semi-crystalline polymer that exhibits a moderate melting temperature T_{M} (60° C.) and a low glass transition temperature T_{g} (−60° C.). Because of these moderate to low temperatures, the applicant has stated the hypothesis that they would favour phase segregation in the block copolymer at a moderate annealation temperature, preferably below 200° C., and with favourable kinetics, preferably below 30 minutes.

However, the applicant has observed that, in a surprising manner, block copolymers comprising a semi-crystalline polycaprolactone PCL block do not exhibit any structuration at the nanometric scale. Even if these block copolymers nanostructure when they are subjected to annealation at a temperature of the order of 100° C. for 12 h, when they are cooled to ambient temperature, crystals appear that destroy the nanostructuration of the block copolymers obtained, so much that at ambient temperature, the block copolymers do not exhibit any nanostructuration. By contrast, when the polycaprolactone block is made amorphous by statistical copolymerization of ε-caprolactone with a co-monomer of similar nature, segregation resulting in structuration at the nanometric scale is observed in the solid state and even at ambient temperature, after cooling after annealation at a temperature of the order of 100° C. for 12 h.

The second block is formed from an oligomer or from a polymer whose chemical nature is incompatible with the first block, and comprising an alcohol function on at least one end. This second alcohol-functionalized polymer makes it possible to act as macro-initiator for the polymerization of the first block, specifically in the presence of methanesulfonic acid (MSA) as catalyst. When it only comprises one hydroxyl function on one end, it makes it possible to produce a diblock copolymer with PCL. When it comprises a hydroxyl function at both its ends, it makes it possible to synthesize a triblock copolymer with PCL blocks at the ends.

In the case of production of a film based on such a block copolymer, comprising a block of amorphous PCL (PCLₐₘ), an annealation treatment at a temperature of between 130 and 170° C. for a very short period, advantageously less than 10 minutes and preferably between 1 and 5 minutes, suffices to observe nanostructuration in the block copolymer film. In this case, treatment of the film by annealation at a temperature below 180° C. improves the mobility of polymer chains and accelerates the copolymer structuration kinetics.

Preferably, the amorphous caprolactone copolymer, intended to form the first polyester block of the block copolymer, is obtained by copolymerization of ε-caprolactone with a monomer having similar nature. Monomer having similar nature to ε-CL is understood to mean a monomer of the monosubstituted ε-lactone or monosubstituted δ-lactone type. Advantageously, the amorphous PCL is therefore formed from ε-caprolactone and at least one other co-monomer chosen from ε- or δ-lactones substituted by aryl or alkyl groups. Among these monomers having similar nature, it emerges that 4-phenyl-caprolactone, denoted 4-Ph-ε-CL in the rest of the description, is the preferred co-monomer, because it means the amorphous caprolactone copolymer can be made at a low molar level, of the order of 15 to 20%. So the caprolactone and 4-phenyl-caprolactone co-monomers form a statistical poly(4-phenyl-caprolactone-r-caprolactone) copolymer, denoted below as P(4-Ph-ε-CL-r-ε-CL).

The fact of replacing a crystalline block of PCL with an amorphous block constituted of a statistical caprolactone copolymer has already been described in the literature, but never with the goal of obtaining nanostructuration of block copolymers intended to serve as nanolithography resists. What is more, in these cases, the proportions of co-monomer necessary to inhibit crystallinity in the PCL are high and comprised between 33 and 50%.

Accordingly, R. Jérôme, R. E. Prud'home et al., in the article entitled “Synthesis, characterization, and miscibility of caprolactone random copolymers,” Macromolecules, 1986, 19, 1828, have shown that statistical copolymerization of ε-caprolactone with 6-Me-ε-caprolactone produces amorphous copolymers for a 50/50 ratio between the monomers. These amorphous copolymers exhibit better miscibility with PVC than semi-crystalline polycaprolactone, as crystal formation reduces this miscibility. These amorphous copolymers are biodegradable and are intended to be used to make subcutaneous implants for drug delivery.

In the article entitled “Triblock copolymers of ε-caprolactone, L-lactide and trimethylene carbonate: biodegradability and elastomeric behavior,” J. Biomedical Materials Research, part A 2011, 99A, 38 L. K. Widjaja et al. have also shown the impact of the crystalline/amorphous nature in the case of elastomeric plastic polymers. When triblock PLA-b-PCL-b-PLA copolymers are prepared, the semi-crystalline nature of the PCL hardens the central block, thus reducing the elastomeric nature. Due to the random copolymerization of ε-caprolactone with trimethylene carbonate, a central amorphous block is obtained with a 50/50 ratio of monomers, which notably increases the elasticity properties.

Finally, in the article entitled “Poly(lactide)-block-poly(ε-caprolactone-co-s-decalactone)-block-poly(lactide) copolymer elastomers,” Polym. Chem. 2015, 6, 3641, M. Hillmyer et al. studied triblock copolymers of PLA-b-PCL-b-PLA, whose central PCL block is semi-crystalline and PLA-b-P(CL-r-DL)-b-PLA, whose central block P(CL-r-DL) is amorphous for a CL/DL ratio of 66/33. They have shown that in both cases, there is micro-phase separation that leads to lamellar or cylindrical morphologies, depending on the composition. The structuration obtained is micrometric and not nanometric. This article does not therefore demonstrate the semi-crystalline or amorphous nature having an impact on the segregation properties of the copolymer obtained. What is more, the extra experimental material published as an appendix to this article explains that the SAXS analyses conducted to show micro-separation of the phases are conducted after annealation at 120° C. for 12 h then at 60° C. for 8 h. The kinetics of structuration of these copolymers is therefore very slow.

The second polymer forming the second block of the block copolymer according to the invention and acting as macro-initiator of polymerization of the first block, and more particularly the statistical copolymer of caprolactone, may advantageously be chosen from an oligomer or a mono- or polyhydroxylated polymer, especially chosen from: (alkoxy)polyalkylene glycols, such as (methoxy)polyethylene glycol (MPEG/PEG), polypropylene glycol (PPG) and polytetramethylene glycol (PTMG); poly(alkyl)alkylene adipate diols, such as poly(2-methyl-1,3-propylene adipate) diol (PMPA) and poly(1,4-butylene adipate) diol (PBA); polysiloxanes, such as mono- or dihydroxylated polydimethylsiloxane (PDMS); mono or dicarbinol; optionally hydrogenated, α-hydroxylated or α,ω-dihydroxylated polydienes, such as α,γ-dihydroxylated polybutadiene or α,ω-dihydroxylated polyisoprene; mono- or polyhydroxylated polyalkylenes such as mono- or polyhydroxylated polyisobutylene; modified or unmodified polysaccharides such as starch, chitin, chitosan, dextran and cellulose; and mixtures thereof.

According to another possibility, the macro-initiator may be a vinyl co-oligomer or copolymer from the family of acrylic, methacrylic, styrene or diene polymers, which results from copolymerization between acrylic, methacrylic, styrene or diene monomers and functional monomers having a hydroxyl group, such as hydroxylated methacrylic or acrylic monomers, such as, for example, 4-hydroxybutyl acrylate, hydroxyethyl acrylate and hydroxyethyl methacrylate. This polymerization may be carried out according to a conventional radical process, a controlled radical process or an anionic process.

According to yet another possibility, the macro-initiator may be a vinyl copolymer obtained by controlled or uncontrolled radical polymerization, in which the radical initiator and/or the control agent bear at least one hydroxyl or thiol function.

Preferably, the macro-initiator is advantageously chosen from hydroxylated polyolefins, that is to say any polymer derived from olefins bearing at least one hydroxylated or hydroxytelechelic function. Polydienes are particularly targeted and, among the polydienes, polybutadienes and most particularly hydroxytelechelic polybutadiene are preferred.

More preferably, the hydroxytelechelic polybutadiene is a polymer sold by Cray Valley under the trade name Krasol® and more particularly Krasol LBH-P3000® and Krasol HLBH-P3000®. Krasol LBH-P3000® is a polybutadiene prepared by anionic polymerization with a number-average molecular weight Mₙ of approximately 3500 g/mol. Krasol HLBH-P3000® is a hydrogenated polybutadiene, the number-average molecular weight Mₙ of which is approximately 3100 g/mol. Such hydroxytelechelic polybutadienes then act as macro-initiators for the polymerization of the first amorphous block, and more particularly co-monomers that constitute the amorphous caprolactone copolymer (PCLₐₘ). These dihydroxylated macro-initiators make it possible to synthesize triblock copolymers of PCL-Krasol®-PCL with a central block of polybutadiene (PBT) type, hydrogenated or non-hydrogenated.

The formulations of Krasol LBH-P3000® and Krasol HLBH-P3000® used are as follows:

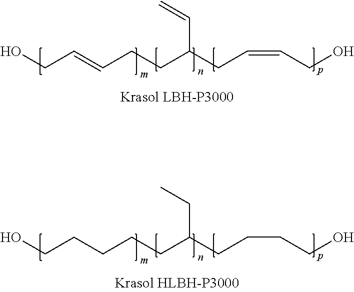

The number-average molecular weight of each block of amorphous copolymer PCL, PCLₐₘ, is advantageously comprised between 1000 and 30,000 g/mol, preferably between 2000 and 15,000 g/mol;

The number-average molecular weight of the block copolymer obtained is between 7000 and 33,000 g/mol.

To obtain an amorphous poly(ε-CL-r-4-Ph-ε-CL) copolymer, the ε-CL/4-Ph-ε-CL molar ratio is between 6/1 and 3/1, and preferably between 6/1 and 4/1, which corresponds to a 4-Ph-ε-CL molar percentage preferably of between 15 and 20%.

The resulting block copolymer is then deposited in the form of a film on a substrate. The process for making such a block copolymer film comprises the steps consisting in synthesizing the block copolymer by mixing the macro-initiator, for example a macro-initiator of hydroxylated polyolefin type, and more particularly a hydroxylated or dihydroxylated polybutadiene, with ε-CL et 4-Ph-ε-CL comonomers, in a solvent, in the presence of methanesulfonic acid as catalyst for the polymerization reaction of the previously cited comonomers, in order to selectively obtain, in one step, a block copolymer of PCLₐₘ-PBT-PCLₐₘ. The solvent is advantageously chosen from toluene, ethylbenzene and xylene. Toluene is, however, preferred to the two other solvents. The catalyst is then eliminated and the block copolymer solution obtained is applied in the form of a film to a surface to be etched, the surface energy of which has been previously neutralized. The solvent of the solution is evaporated and the film is subjected to annealing at a determined temperature of between 130 and 170° C., for a period of less than 30 minutes, and preferably less than 15 minutes, to ensure the nanostructuring of the copolymer in nanodomains perpendicular to the surface to be etched. An annealation temperature of between 130 and 170° C. is sufficient to produce nanostructuration in a short period of the order of a few minutes, preferably less than 15 minutes, and more preferably below 5 minutes and ideally of between 1 and 2 minutes.

Generally, in the case of lithography, the desired structuring, for example the generation of nanodomains perpendicular to the surface, requires, however, the preparation of the surface on which the copolymer solution is deposited with a view to controlling the surface energy. Among the known possibilities, a random copolymer, the monomers of which can be entirely or partially identical to those used in the block copolymer which it is desired to deposit, is deposited on the surface. In a pioneering article, Mansky et al. (Science, Vol. 275, pages 1458-1460, 1997) gives a good description of this technology, now well known to those skilled in the art.

Mention may be made, among the favoured surfaces, of the surfaces consisting of silicon, the silicon having a native or thermal oxide layer, germanium, platinum, tungsten, gold, titanium nitrides, graphenes, BARC (Bottom Anti-Reflective Coating) or any other anti-reflective layer used in lithography.

Once the surface has been prepared, a solution of the block copolymer according to the invention is deposited and then the solvent is evaporated off according to techniques known to those skilled in the art, such as, for example, the spin coating, doctor blade, knife system or slot die system technique, but any other technique can be used, such as dry deposition, that is to say deposition without involving a predissolution.

A heat treatment is then carried out, which enables the block copolymer to become correctly organized, that is to say to especially obtain a phase separation between the nanodomains, the size of which is less than 10 nm, with a controlled morphology and a period of less than 20 nm, a preferred orientation of the domains perpendicular to the surface to be etched, and a reduction in the number of defects. The temperature T of this heat treatment is preferably such that it is less than 180° C. and greater than the highest glass transition temperature of the blocks constituting the copolymer. It is carried out under a solvent atmosphere, or thermally, or by a combination of these two methods.

Depending on whether the macro-initiator is mono- or dihydroxylated, the copolymer obtained is a diblock copolymer of PCLₐₘ-PBT type or triblock copolymer of PCLₐₘ-PBT-PCLₐₘ type.

The block copolymer according to the invention is preferably synthesized at a temperature ranging from 20 to 120° C. and more preferentially between 30 and 60° C., in particular when the solvent is toluene. Indeed, when the macro-initiator is a hydrogenated or non-hydrogenated hydroxytelechelic polybutadiene, it is possible to obtain, at a temperature of approximately 30° C., PCLₐₘ-b-Krasol®-b-PCLₐₘ or PCLₐₘ-b-Krasol® H-b-PCLₐₘ block copolymers having number-average molecular weights Mₙ ranging up to 33,000 g/mol in a few hours and with a yield of greater than or equal to 85% after purification.

The molar ratio of initiator/catalyst (MSA) is preferably between 1/1 and 1/2.

Finally, the reagents used in this process are preferably dried before being used, especially by vacuum treatment, distillation or drying using an inert desiccant.

The cylindrical or lamellar morphology of the nanodomains formed in this way depends on the molar ratio of comonomers ε-CL and 4-Ph-ε-CL to macro-initiator in the starting mixture, but also on the nature of the macro-initiator forming the second block of the block copolymer and on its degree of polymerization.

The molar ratio of ε-CL and 4-Ph-ε-CL comonomers relative to each end function of the macro-initiator is preferably comprised between 16/1 and 130/1.

After having synthesized the block copolymer, having deposited it in film form on a surface to be etched and having subjected it to annealing in accordance with the preceding description, the first biodegradable PCLₐₘ block is advantageously removed to form a nanolithography resist comprising a porous pattern perpendicular to the surface to be etched and having a period L₀≤20 nm.

A block copolymer according to the invention therefore makes it possible to obtain an assembly of blocks perpendicular to the surface on which it is deposited, with considerable phase segregation, making it possible to obtain nanodomains of small sizes, of approximately a nanometre to a few nanometres, and of controlled morphology and a period of less than or equal to 20 nm. Such a block copolymer therefore allows better control of the lithography process, the resolution of which is high and compatible with the current requirements in terms of component dimensions.

The inhibition of crystallinity in block copolymers comprising a block of PCL obtained by statistical copolymerization of ε-CL with 4-Ph-ε-CL, with only 15 to 20 mol % of the 4-Ph-ε-CL co-monomer, allows the production of block copolymers capable of segregating, leading to structuration on the nanometric scale, whereas no nano-structuration is observed for copolymers comprising a semi-crystalline PCL block.

What is more, the copolymers obtained from amorphous polyester, and more particularly from amorphous PCL, are capable of segregating at low molar masses, typically comprised between 4000 and 30,000 g/mol, by treatment at low annealation temperatures (<180° C.) and in a very short period (<10 min). Morphologies in well-defined domains are then obtained with low periods L₀ (<20 nm).

This behaviour proves particularly advantageous in the context of applications in DSA (directed self-assembly) lithography, in which it is sought to obtain nanostructuring in periodic structures with very small copolymer periods, if possible at low temperature and in short periods, in order to obtain lithography resists with very high resolutions.

### The Following Examples Nonlimitingly Illustrate the Scope of the Invention:

For the preparation of block copolymers by polymerization by ring opening of cyclic lactones and carbonates with sulfonic acids as catalysts, triblock copolymers based on semi-crystalline polycaprolactone (PCL) and amorphous poly(4-phenyl-caprolactone-r-caprolactone) were prepared, in order to be compared. The Krasol LBH-P3000® and Krasol HLBH-P3000® dihydroxylated telechelic polymers were used as macro-initiators, in order to have a central block of hydrogenated or unhydrogenated polybutadiene type.

The sulfonic acid used as catalyst in the copolymerization reaction is methanesulfonic acid (MSA).

The copolymerization reactions of ε-CL monomer and poly(4-Ph-ε-CL-r-ε-CL) copolymer with respectively KrasolLBH and KrasolHLBH macro-initiators, in the presence of MSA as catalyst, are as follows:

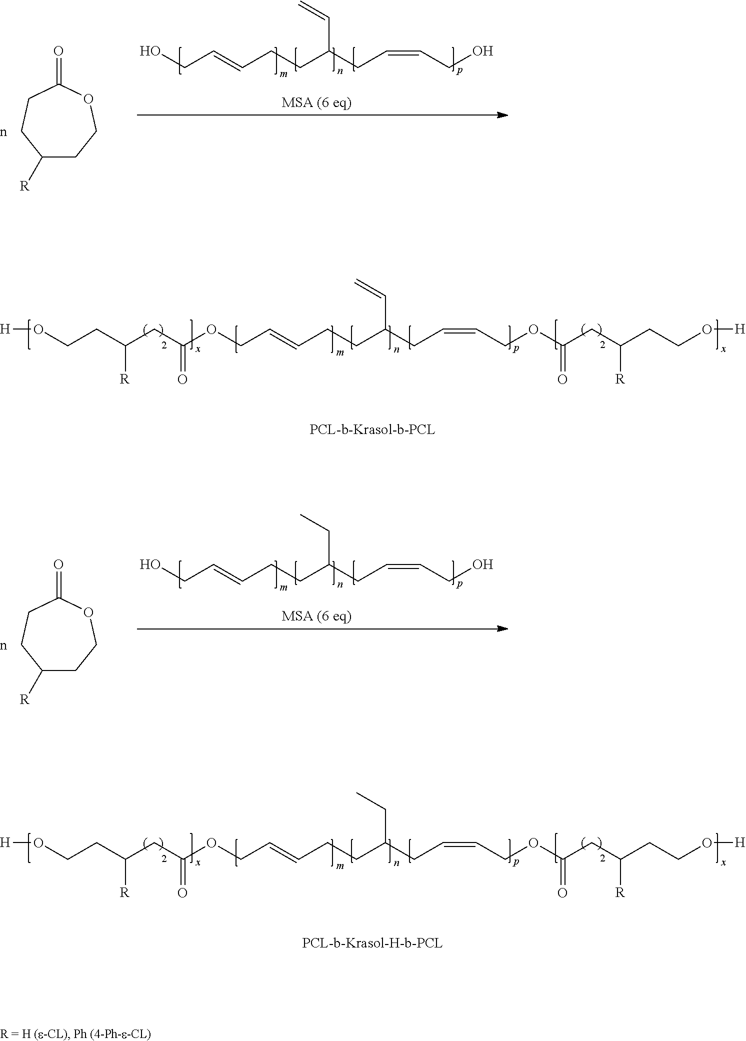

The following general procedure was used to carry out the processes described below.

The toluene was dried using an MBraun SPS-800 solvent purification system. Methanesulfonic acid (MSA) was used as extra purification. The diisopropylethylamine (DIEA) was dried and distilled over CaH₂ and stored over potassium hydroxide (KOH). ε-caprolactone dried over CaH₂ then distilled was stored under an inert atmosphere. 4-Ph-ε-CL was recrystallized with toluene then dried over P₂O₅ and stored under an inert atmosphere.

The Schlenk tubes were dried with a heat gun under vacuum in order to remove any trace of moisture.

The reaction was monitored by ¹H NMR (proton nuclear magnetic resonance) on Brucker Avance 300 and 500 machines and by size exclusion chromatography (SEC) in THF. For this purpose, samples were withdrawn, neutralized with DIEA (Diisopropylethyl amine), evaporated and taken up in an appropriate solvent with a view to their characterization. ¹H NMR makes it possible to quantify the degrees of polymerization (DPs) of the co-monomers of ε-CL and 4-Ph-ε-CL by determining the integration ratio of half of the signals of the —CH₂— groups bearing the OC(═O) functional group and the C═O functional group, respectively, to the signals of the CH₂ protons bearing the —OH functional group initially on the initiator. The spectra are recorded in deuterated chloroform on a 300 MHz spectrometer. The number-average molecular weight Mn and the degree of polydispersity (Ð) of the samples of copolymers withdrawn are measured by size exclusion chromatography SEC in THF with polystyrene calibration.

The measurement by differential scanning calorimetry, denoted DSC, makes it possible to study the glass transitions and the crystallization. DSC is a thermal analysis technique which makes it possible to measure the differences in the exchanges of heat between a sample to be analyzed and a reference during phase transitions. A Netzsch DSC204 differential scanning calorimeter was used to carry out this study.

The calorimetry analyses were carried out between −80 and 130° C. and the temperature values were recorded during the second rise in temperature (at a rate of 10° C./min).

Analysis by small angle X-ray scattering, denoted SAXS, makes it possible to study the structural properties of the block copolymers synthesized on a scale smaller than 100 nm. This analytical technique consists in causing monochromatic radiation to scatter through the sample to be analysed. The scattered intensity is collected as a function of the scattering angle passing through the sample, the scattering angle being very close to the direct beam. The scattered photons provide information relating to the fluctuation of the electron densities in the heterogeneous material. To carry out SAXS analyses, a Nanostar SAXS (Bruker) apparatus or the BM-26B station of the DUBBLE line at the European synchrotron Radiation Facility (ESFR) was used.

In the following examples, triblock copolymers, based on semi-crystalline polycaprolactone (PCL) on the one hand and based on amorphous poly (ε-CL-co-4-Ph-ε-CL) on the other were prepared and compared.

In all the cases the polymerization of PCL or P(CL-co-4-Ph-CL) is total and takes place with a very good level of control, that is to say with effective incorporation of the polyester block onto the hydroxylated ends of the polybutadienes (Krasol) and with a very low impact on the transfer reactions. The block structure of the copolymer is confirmed by NMR and SEC analyses of the polymers.

The ability of these copolymers to segregate and to become nanostructured was firstly studied by DSC then by SAXS and/or microscopy analysis was also carried out. The results of the analyses are collated in table I below.

### Example 1 (Comparative): Preparation of a tri-block poly(ε-caprolactone)₄₃-block-Krasol LBH-P3000-block-poly(ε-caprolactone)₄₃ copolymer

The macro-initiator (Krasol LBH-P3000, 1 eq., 1.5 g) and the ε-CL (90 eq., 4.11 g) were weighed in a glovebox and added to a dry Schlenk flask. The Schlenk flask was placed under a controlled argon atmosphere, then the solvent (9 ml of toluene, [ε-CL]₀=4 mol/l) and methanesulphonic acid (1 eq., 78 μl) were added successively. The reaction medium was stirred under argon at 30° C. for 2 h 30. Once the monomer had been entirely consumed, established from ¹H NMR monitoring, an excess of diisopropylethylamine (DIEA) or Amberlyst 21 was added to neutralize the acid catalyst. The solvent was then evaporated under vacuum. The polymer obtained was then dissolved in the minimum amount of dichloromethane, then precipitated by addition to cold methanol, filtered and dried under vacuum.

The polymerization reaction of the ε-CL monomer with the macro-initiator was as follows:

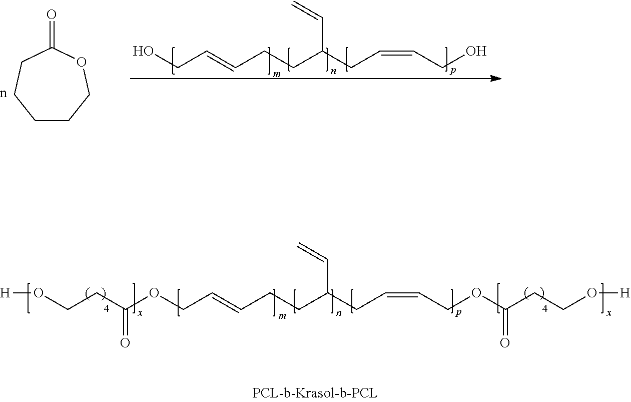

The results obtained were as follows:

A PCL₄₃-b-Krasol®-b-PCL₄₃ triblock copolymer was obtained with a conversion rate of 99% and a yield of greater than 90%.

SEC: Mₙ=18,000 g/mol; Ð=1.18

DSC: T_{g}: −55.4° C.; T_{f}: 52.7° C.; overall degree of crystallinity=45%

¹H NMR (CDCl₃, 300 MHz): 5.70-5.20 (m, 40×1H, CHCH═CH₂+2×2×10H, —CH—CH═CH—CH—), 5.00-4.80 (m, 1×40×2H, CH—CH═CH₂), 4.10-4.00 (m, 86×2H, OCH₂CH₂), 3.70-3.60 (m, 2×2H, terminal CH₂OH), 2.40-2.20 (m, 86×2H, COCH₂), 2.20-1.75 (m, 40×1H, CHCH═CH₂+2×2×10×2H, —CH₂—CH═CH—CH₂—), 1.70-1.50 (m, 2×86×2H, COCH₂CH₂CH₂CH₂CH₂O), 1.45-1.10 (m, 86×2H, COCH₂CH₂CH₂CH₂CH₂O, 40×2H, CH₂—CH₂—CH).

### Composition 2 (Invention) Preparation of a “PCL_{am.}”₄₂-b-Krasol LBH-P3000-b-“PCL_{am.}”₄₂ triblock copolymer

The macro-initiator (Krasol LBH-P3000, 1 eq., 0.53 g) and also the ε-CL (72 eq., 1.16 g) and 4-Ph-ε-CL(18 eq., 0.48 g) were weighed in a glovebox and added to a dry Schlenk flask. The Schlenk flask was placed under a controlled argon atmosphere, then the solvent (12.6 ml of toluene, [M]₀=1 mol/l) and methanesulfonic acid (2 eq., 19 μl) were added successively. The reaction medium was stirred under argon at 30° C. for 1 h 10. Once the monomer had been entirely consumed, established from ¹H NMR monitoring, an excess of diisopropylethylamine (DIEA) or Amberlyst 21 was added to neutralize the acid catalyst. The solvent was then evaporated under vacuum. The polymer obtained was then dissolved in the minimum amount of dichloromethane, then precipitated by addition to cold methanol, filtered and dried under vacuum.

The results obtained were as follows:

A “PCL_{am.}”₄₂-b-Krasol LBH-P3000-b-“PCL_{am.}”₄₂ triblock copolymer was obtained with a conversion rate of 88% and a yield of greater than 83%.

SEC: Mₙ=13,000 g/mol; Ð=1.23

DSC: T_{g}: −53.8° C.; T_{f}:—amorphous

¹H NMR (CDCl₃, 300 MHz): 7.40-7.10 (m, 12×5H, Ph, CHCl₃), 5.70-5.20 (m, 40×1H, CHCH═CH₂+2×2×10H, —CH—CH═CH—CH—), 5.00-4.80 (m, 1×40×2H, CH—CH═CH₂), 4.05-3.75 (m, 70×2H, CH₂O(C═O)C+12×2H, CH₂O(C═O)C), 3.70-3.45 (m, 2×2H, terminal CH₂OH), 2.70-2.50 (m, 12×1 H, CH(C₆H₅)), 2.40-2.20 (m, 70×2H, COCH₂), 1.75-2.20 (m, 12×2H, O(C═O)CH₂, 12×2×2H, O(C═O)CH₂CH₂CHCH₂, 40×1H, CHCH═CH₂+2×2×10×2H, —CH₂—CH═CH—CH₂—), 1.70-1.50 (m, 2×70×2H, COCH₂CH₂CH₂CH₂CH₂O), 1.45-1.10 (m, 2×40×2H, COCH₂CH₂CH₂CH₂CH₂O, 40×2H, CH₂—CH₂—CH).

### Example 3 (Comparative): Preparation of a tri-block poly(ε-caprolactone)₃₆-block-Krasol HLBH-P3000-block-poly(ε-caprolactone)₃₆ copolymer

The macro-initiator (Krasol LBH-P3000, 1 eq., 0.33 g) and the ε-CL (70 eq., 0.75 g) were weighed in a glovebox and added to a dry Schlenk flask. The Schlenk flask was placed under a controlled argon atmosphere, then the solvent (6.6 ml of toluene, [ε-CL]₀=1 mol/l) and methanesulfonic acid (2 eq., 7.3 μl) were added successively. The reaction medium was stirred under argon at 30° C. for 1 h 30. Once the monomer had been entirely consumed, established from ¹H NMR monitoring, an excess of diisopropylethylamine (DIEA) or Amberlyst 21 was added to neutralize the acid catalyst. The solvent was then evaporated under vacuum. The polymer obtained was then dissolved in the minimum amount of dichloromethane, then precipitated by addition to cold methanol, filtered and dried under vacuum.

The results obtained were as follows:

A poly(ε-caprolactone)₃₆-block-Krasol H LB H-P3000-block-poly(ε-caprolactone)₃₆ triblock copolymer was obtained with a conversion rate of 99% and a yield of greater than 90%.

SEC: Mₙ=20,000 g/mol; Ð=1.04

DSC: T_{g}: −55° C.; T_{f}: 53.4° C.; overall degree of crystallinity=42%

¹H NMR (CDCl₃, 300 MHz): 4.10-4.00 (m, 72×2H, CH₂O(C═O)C), 3.70-3.60 (m, 2×2H, terminal CH₂OH), 2.40-2.20 (m, 72×2H, COCH₂), 1.70-1.50 (m, 2×72×2H, COCH₂CH₂CH₂CH₂CH₂O), 1.45-0.95 (m, 72×2H, COCH₂CH₂CH₂CH₂CH₂O, 36×1H, CH₂—CH—CH₂+2×36×2H, CH—CH₂—CH₃+2×4×10×2H, —CH₂—CH₂—CH₂—), 0.95-0.75 (m, 36×3H, CH₂—CH₃)

### Example 4 (Invention): Preparation of a “PCL_{am.}”₃₆-b-Krasol HLBH-P3000-b-“PCL_{am.}”₃₆ Triblock Copolymer

The macro-initiator (Krasol HLBH-P3000, 1 eq., 0.55 g) and also the ε-CL (56 eq., 1.16 g) and 4-Ph-ε-CL(14 eq., 0.48 g) were weighed in a glovebox and added to a dry Schlenk flask. The Schlenk flask was placed under a controlled argon atmosphere, then the solvent (3.7 ml of toluene, [β-BL]₀=4 mol/l) and methanesulfonic acid (2 eq., 45 μl) were added successively. The reaction medium was stirred under argon at 30° C. for 1h15. Once the monomer had been entirely consumed, established from ¹H NMR monitoring, an excess of diisopropylethylamine (DIEA) or Amberlyst 21 was added to neutralize the acid catalyst. The solvent was then evaporated under vacuum. The polymer obtained was then dissolved in the minimum amount of dichloromethane, then precipitated by addition to cold methanol, filtered and dried under vacuum.

The results obtained were as follows:

A “PCL_{am.}”₃₆-b-Krasol HLBH-P3000-b-“PCL_{am.}”₃₆ triblock copolymer was obtained with a conversion rate of 99% and a yield of greater than 90%.

SEC: Mₙ=14,500 g/mol; Ð=1.23

DSC: T_{g}: −54.2° C.; T_{f}:—amorphous

¹H NMR (CDCl₃, 300 MHz): 7.35-7.00 (m, 11×5H, Ph, CHCl₃), 4.10-3.75 (m, 56×2H, CH₂O(C═O)C+11×2H, CH₂O(C═O)C), 3.70-3.45 (m, 2×2H, terminal CH₂OH), 2.70-2.50 (m, 11×1H, CH(C₆H₅)), 2.40-2.20 (m, 56×2H, COCH₂), 2.15-1.75 (m, 11×2H, O(C═O)CH₂, 11×2×2H, O(C═O)CH₂CH₂CHCH₂), 1.70-1.50 (m, 2×56×2H, COCH₂CH₂CH₂CH₂CH₂O), 1.45-0.95 (m, 56×2H, COCH₂CH₂CH₂CH₂CH₂O, 36×1H, CH₂—CH—CH₂+2×36×2H, CH—CH₂—CH₃+2×4×10×2H, —CH₂—CH₂—CH₂—), 0.95-0.75 (m, 36×3H, CH₂—CH₃).

The thermal analyses (DSC) of the copolymers studied shows a single glass transition temperature because the two blocks have very similar T_{g} (PCL, −60° C. and Krasol −55° C.). Given the proximity of the T_{g} values of the corresponding homopolymers (for PCL, Tg=−60° C. and for Krasol, Tg=−55° C.) it is difficult to draw conclusions as to the ability of these blocks to segregate solely based on DSC analysis. It should also be noted that block copolymers comprising the PCL block are semi-crystalline in nature, whereas those with the PCLₐₘ block are amorphous in nature.

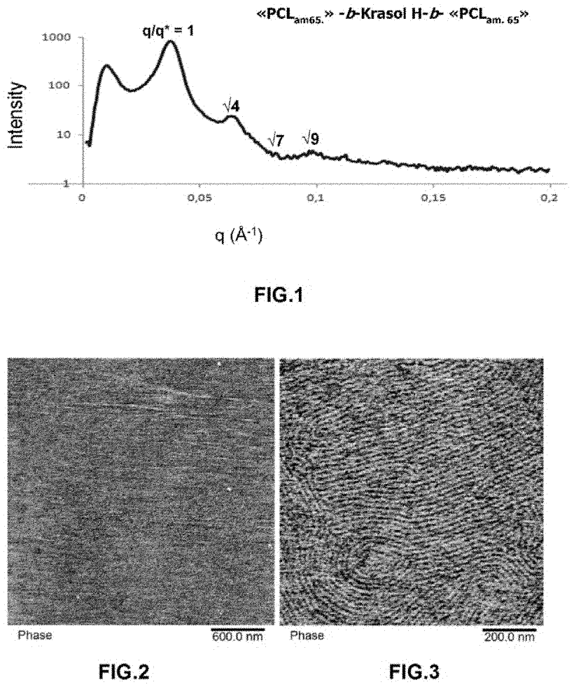

SAXS analyses shed more light on the different behaviour of block copolymers according to whether they incorporate PCL or PCLₐₘ end blocks. For the copolymers based on (semi-crystalline) PCL, there is no nanostructuring with a well-defined morphology, but rather simply a separation of the phases due to the crystallinity of the PCL, and the amorphous PCL/Krasol phases seem to be miscible. On the other hand, in the case of the PCLₐₘ block, nanostructuring with a well-defined morphology is observed, in particular with hydrogenated Krasol. The nano-structuration morphology is cylindrical for the cases observed and shown in Table I below. FIG. 1 illustrates the curve obtained by SAXS analysis of a PCL_{am.65}-b-Krasol H-b-PCL_{am.65} film where q corresponds to the angle of diffusion over the wavelength used, q* corresponds more particularly to the most intense diffusion. The values obtained for q/q* for the different peaks (1, √4, √7, √9) are characteristic of a cylindrical hexagonal arrangement with a mean period L₀ of 17.3 nm. SAXS analyses of the block copolymers were conducted on polymers such as those obtained during the synthesis-purification, after annealing at 100° C. for 12 h.

The triblock copolymers in examples 5 to 9 of Table I below were synthesized according to the same protocol as that described in examples 1 to 4.

The PCLₐₘ-b-Krasol-b-PCLₐₘ or PCLₐₘ-b-Krasol H-b-PCLₐₘ triblock copolymers that lead to nano-structuration were then chosen for microscopy analysis, more particularly PCLₐₘ-b-Krasol H-b-PCLₐₘ. For this purpose, a solution of copolymer is deposited in the form of a thin film 140 nm thick on a surface, then the solvent is evaporated and the film is annealed at a temperature of between 130 and 170° C. for a period of between 5 and 10 minutes. In the examples in Table I above, the film of PCL_{am.65}“-b-Krasol H-b-”PCL_{am.65} was annealed at a temperature of 150° C. for 5 minutes. Cylindrical nano-structuration with period L₀ equal to 17 nm was then observed. The same film of PCL_{am.65}“-b-Krasol H-b-”PCL_{am.65} was also annealed at 170° C. for 10 minutes. Cylindrical nano-structuration with period L₀ equal to 19 nm was then observed. The results of microscopy analysis confirm nanostructuring with nanodomains perpendicular to the surface and having a mean period L₀ of below 20 nm. The film can be observed by atomic force microscopy (AFM) after annealing for 5 minutes at 150° C. in FIG. 2, and the same film after annealing for 10 minutes at 170° C. in FIG. 3.

The block copolymers incorporating an amorphous caprolactone copolymer polyester block are thus capable of segregating, giving rise to structuring on the nanometre scale, whereas no nanostructuring is observed for the triblock copolymers of equivalent size based on semi-crystalline polycaprolactone.

Moreover, the copolymers obtained based on PCLₐₘ are capable of segregating for low molecular weights, typically of less than 33,000 g/mol, enabling various morphologies to be achieved depending on their composition, with very small structuring periods of less than 20 nm.

This behaviour proves particularly advantageous in the context of applications in DSA (directed self-assembly) nanolithography, in which it is sought to obtain nanostructuring in periodic structures with very small copolymer periods, in order to obtain nanolithography resists with very high resolutions.

The copolymer according to the invention differs very greatly from conventional PS-b-PMMA block copolymers which do not make it possible to obtain periods smaller than 20 nm.

TABLE I

| | | | | | | | | Global |
|---|---|---|---|---|---|---|---|---|
| | | | Krasol | Polyester | | | | crystallinity/relative |
| | | Mn* | molar | molar | Mn^{#} | | Tg° | to the polyester |
| Example | Composition* | (g/mol) | fraction | fraction | (g/mol) | Ð^{#} | (° C.) | block° (%) |
| 1 | PCL₄₃- | 13,300 | 0.26 | 0.74 | 18,000 | 1.18 | −55.4 | 45/61 |
| | Krasol-PCL₄₃ | | | | | | | |
| 2 | “PCL_{am.42}”- | 14,500 | 0.24 | 0.76 | 13,000 | 1.23 | −53.8 | 0 |
| | Krasol- | | | | | | | |
| | “PCL_{am.42}” | | | | | | | |
| 3 | PCL₃₆-Krasol | 11,300 | 0.27 | 0.73 | 20,000 | 1.04 | −55 | 42/58 |
| | H-PCL₃₆ | | | | | | | |
| 4 | “PCL_{am.36}”- | 12,200 | 0.24 | 0.76 | 14,500 | 1.23 | −54.2 | 0 |
| | Krasol H- | | | | | | | |
| | “PCL_{am.36}” | | | | | | | |
| 5 | PCL₂₁- | 8,300 | 0.42 | 0.58 | 14,000 | 1.12 | −45.8 | 40/69 |
| | Krasol-PCL₂₁ | | | | | | | |
| 6 | PCL₈₀- | 21,800 | 0.16 | 0.84 | 33,000 | 1.13 | −55.6 | 42/50 |
| | Krasol-PCL₈₀ | | | | | | | |
| 7 | “PCL_{am.89}”- | 26,500 | 0.13 | 0.87 | 25,500 | 1.19 | −51.6 | 0 |
| | Krasol- | | | | | | | |
| | “PCL_{am.89}” | | | | | | | |
| 8 | PCL₇₀-Krasol | 19,100 | 0.16 | 0.84 | 27,500 | 1.10 | −53.9 | 41/49 |
| | H-PCL₇₀ | | | | | | | |
| 9 | “PCL_{am.65}”- | 19,900 | 0.16 | 0.84 | 21,100 | 1.21 | −53.3 | 0 |
| | Krasol H- | | | | | | | |
| | “PCL_{am.65}” | | | | | | | |

*determined by ¹H NMR (300 MHz) where Mn_{Krasol} = 3500 g/mol and Mn_{Krasol H} = 3100 g/mol;
^{#}determined by SEC, PS standards;
°determined by DSC T_{g Krasol} = −55.4° C. and T_{gKrasol H} = −63.8° C.;
“PCL_{am.}” with ε-CL/4-Ph-ε-CL = 4/1

1. Block copolymer film nanostructured in nanodomains, said copolymer comprising at least one first biodegradable block of polyester type and a second block of a different chemical nature than the first block, said block copolymer being characterized in that the first biodegradable block of polyester type is amorphous and chosen from ε- or δ-lactone polymers and in that the second block is derived from an oligomer or a polymer bearing a hydroxyl function on at least one end and acting as macro-initiator of the polymerization of the first block.

2. Block copolymer film according to claim 1, wherein the first amorphous biodegradable block of polyester type is chosen from ε- or δ-lactone polymers substituted or unsubstituted by aryl or alkyl groups.

3. Block copolymer film according to claim 1, wherein the first amorphous biodegradable block of polyester type is an amorphous caprolactone copolymer (PCLₐₘ) formed from ε-caprolactone and at least one other co-monomer chosen from ε- or δ-lactones substituted by aryl or alkyl groups.

4. Block copolymer film according to claim 1, wherein the block copolymer is a diblock or triblock copolymer.

5. Block copolymer film according to claim 3, wherein characterized in that the co-monomers that constitute the amorphous caprolactone copolymer (PCLₐₘ) are ε-caprolactone (ε-CL) and 4-phenyl-caprolactone (4-Ph-ε-CL).

6. Block copolymer film according to claim 5, wherein the molar ratio between the ε-CL/4-Ph-ε-CL co-monomers is comprised between 6/1 and 3/1.

7. Block copolymer film according to claim 3, wherein the number-average molecular weight of each block of amorphous caprolactone copolymer (PCLₐₘ) is comprised between 1000 and 30000 g/mol.

8. Block copolymer film according to claim 1 one of claims 1 to 7, wherein the number-average molecular weight of the block copolymer is between 7000 and 33,000 g/mol.

9. Block copolymer film according to claim 3, wherein the molar ratio of ε-caprolactone and 4-Ph-ε-CL co-monomers on each hydroxyl function of the macro-initiator is comprised between 16/1 and 130/1.

10. Block copolymer film according to claim 1, wherein the second block forming macro-initiator is derived from an oligomer or from a mono- or polyhydroxylated polymer chosen from:
(alkoxy)polyalkylene glycols;
poly(alkyl)alkylene adipate diols; or
polysiloxanes, mono- or di-carbinol or
optionally hydrogenated mono- or dihydroxylated polydienes; or
mono- or polyhydroxylated polyalkylenes; modified or unmodified polysaccharides; or
a vinyl co-oligomer or copolymer from the family of acrylic, methacrylic, styrene or diene polymers, which results from copolymerization between acrylic, methacrylic, styrene or diene monomers and functional monomers having a hydroxyl group, or
a vinyl copolymer obtained by radical polymerization, controlled or uncontrolled, in which the radical initiator and/or the control agent bear at least one hydroxyl or thiol function.
